(19) United States
(12) Patent Application Publication
(10) Pub. No.: US 2010/0211472 A1
(43) Pub. Date: Aug. 19, 2010

(54) AFFILIATE SYSTEM HAVING LINKAGE FUNCTION WITH CLEARING SYSTEM

(75) Inventor: Yasuyoshi Shimooka, Yachimata-shi (JP)

Correspondence Address: SUGHRUE MION, PLLC, 2100 PENNSYLVANIA AVENUE, N.W., SUITE 800, WASHINGTON, DC, 20037, US

(73) Assignee: INFOCART, INC., Yachimata-shi, Chiba (JP)

(21) Appl. No.: 12/160,643

(22) PCT Filed: Oct. 17, 2007
(86) PCT No.: PCT/JP2007/070682

§ 371 Date: Jul. 11, 2008

(51) Int. Cl. G06Q 30/00; G06Q 10/00; G06Q 20/00

(52) U.S. Cl. 705/26; 705/34; 705/30

(57) ABSTRACT

The clearing system comprises an affiliate linkage process means which sends a clearing completion notice, including the clearing information on the cost of the commodity purchased by a user at the shop site, to the affiliate sales system in accordance with the billing API while receiving the compensation information including the compensation to be paid from the affiliate sales system to the affiliates in accordance with the billing API, and performs the process of transferring to the shop account of the shop site the balance of the cost of the commodity from which the compensation is deducted; and the affiliate sales system comprises a clearing linkage process means which receives a clearing completion notice from the clearing system in accordance with the billing API while determining the compensation based on the clearing information and returning the compensation information to the clearing system.

### FIELD OF THE INVENTION

The present invention relates to a computer system that executes an affiliate program, and more specifically, it relates to a system that enables the carrying out of an automatic payment to exhibitor shops or the payment of compensation to affiliates by providing a link between the computer system of an affiliate service provider and the clearing system of a clearing company.

### BACKGROUND OF THE INVENTION

In recent years, affiliate programs (also called “associate programs”) have been drawing attention as a new method of advertising. An affiliate program is an advertisement delivery method of the reward-for-performance type wherein the advertising fee is paid to the affiliates only when a user generates some sort of transaction (like a commodity purchase, survey entry, membership registration, or the like) using a browser. In the affiliate program, the operator of a personal or corporate website or e-mail newsletter places the advertisements of advertisers (merchants) on its own site so as to facilitate the guiding of visitors of those sites to the advertiser's EC (Electronic Commerce) sites. The guided visitors then proceed to the EC sites via the advertisement, and when a service or commodity is purchased, or a membership subscription is obtained, a reward for the uptake of the service or membership or the like is generated for the guiding source site.

In order to perform the affiliate program it is necessary, for example, to identify the merchant site browsed by the user and perform the process of tracking the information channel up to the eventual generation of an event (commodity purchase order, survey entry, membership registration order, or the like) that is involved in the transaction by the browser. Such a tracking process employs a cookie. For example, there is a method wherein tracking information (such as the URL of an affiliate ID) is incorporated into a URL that guides a user to link with a seller's site so as to carry out the calculation of a reward for success for the affiliate by using the information (for example, see Japanese Unexamined Patent Application Publication No. 2006-113884).

FIG. 1 shows a pattern diagram indicating the process flow of a conventional affiliate system, and an overview of the process of the conventional system is described with reference to the same figure. An ASP (Affiliate Service Provider) 3 in FIG. 1 refers to a provider that acts to perform the affiliate program. An advertiser 6 in FIG. 1 refers to an advertiser who desires to sell commodities (contents, such as digital commodities, paid e-mail newsletters, and goods) by using the affiliate's service functions provided by the ASP 3.

The advertiser 6, when using the affiliate service provided by the ASP 3, applies to an affiliate entity (an entity that operates and manages the ASP), which is separate to an entity that supplies shopping carts and other such functions, for the registration of sales target commodities, and then obtains an approval from the affiliate entity. The ASP 3 then receives information about the commodities applied for by the advertiser from the communication terminal of the advertiser via a network in order to store them, along with the membership information on the advertiser 6, into a database.

Conversely, for affiliates 2 to which the membership registration was made, the ASP 3 displays the information on the commodities registered by the advertiser 6, for example, on the login screen of the terminal.

The affiliates 2, via the ASP, sends to the communication terminal (or website) of the advertiser 6 a list of commodities that they desire to have introduced in order to apply for a business alliance with the advertiser 6. The advertiser 6 that receives the application from the affiliates 2, when approving the application, notifies the affiliates 2 of the permission of use (advertisement) of such commodities via the ASP 3. Every time there is an application for a new list (new commodities) from the affiliates 2, the advertiser 6 performs the approval work and notifies the affiliates 2 of the permission of use of such commodities.

Conversely, an EC site (a virtual shop site) 10 that exhibits the commodities of the advertiser 6, upon receiving from a user terminal an order instruction of desired-to-be-purchased commodities that have been put in a shopping cart 11A, sends the order information on the commodities to a clearing system 4 of the clearing company in order to request the clearing process for the cost of the commodities for which an order was received.

The EC site 10 in the present example incorporates a commodity tag (electronic tag) including a code that identifies the commodity being put into the shopping cart 11A in order to store the tag information so that the sales counter corresponding to the commodity tag is counted up every time a sale of the ordered commodity is generated. The ASP 3 then performs the invoicing of a system usage fee for the shops in the EC site 10, and the compensation payment process for the affiliates based on the sales count information in the commodity tag uploaded from the EC site 10 begins.

The mechanism of paying the compensation to the affiliates will now be described in further detail with reference to FIG. 2.

A user 1 accesses the EC site 10 from a user terminal used to display a commodity screen 11 and puts desired-to-be-purchased commodities into the shopping cart. The user then enters the information necessary for card clearing on the purchase screen (clearing screen 4a) in order to place an order. The EC site 10 that received the order incorporates a commodity tag into the commodities in the shopping cart, with there being one for each commodity, and stores the tag information in a storage section while sending the order information on the commodities to the clearing system 4 of the clearing company in order to request the card clearing process for the cost of the commodity.

The clearing system 4 that received the order information processes a user authentication with the computer of the card company corresponding to the card number of the user and subsequently sends the completion notice (order reception completion notice) to the EC site 10. The EC site 10 that received the completion notice from the clearing system 4 calls for the tags at completion so that the counting-up of the commodity sales is sent to the ASP 3 while informing, by displaying a completion screen on the display part of the user terminal, the user of the completion of the order reception for the commodities purchased.

If the sold commodities are the commodities that were introduced by the affiliates 2, the ASP 3 that received the completion notice and the tags sends the commodity information to the terminal of the affiliates 2 in order to inform them that the introduced commodities were ordered.

Subsequently, the clearing system 4, upon completing the payment transfer process for the cost of the commodity (being the cost from which a clearing commission was deducted) to the account of the EC site 10 (exhibitor shop), informs the EC site 10 of completion of the payment transfer for the cost of the commodity (see S1 to S3 in FIG. 2).

The EC site 10 maintains a record of the counting-up of the sales counter of the commodity corresponding to the tag information stored in the storage section upon generation of commodity sales so that the sales counter information can be sent to the ASP 3, for example, at the end of each month (see S4 in FIG. 2).

If the sold commodities are the commodities that were introduced by the affiliates, the ASP 3 calculates the sales achieved based on the sales count information received from the EC site 10 in order to compute the compensation corresponding to the sales achieved as a reward for success. Then, for example, at the end of the month, the monthly usage fee of the ASP 3 and the fee for the reward for success for the affiliates are calculated, and subsequently an invoice is sent to the EC site 10 (see S5 in FIG. 2). The EC site 10 pays the system usage fee of the ASP 3 by, for example, transferring the amount billed by the invoice to the account of the ASP entity (see S6 in FIG. 2). The ASP 3, when confirming the transfer of the system usage fee by the EC site 10, pays the compensation (incentive) to the affiliates 2 by, for example, transferring the fee for the reward for success to the specified account of the affiliates (see S7 in FIG. 2) in order to complete the processing of the commodities sold (refer to, for example, Japanese Unexamined Patent Application Publication No. 2006-113884 and Japanese Unexamined Patent Application Publication No. 2002-24687 for a conventional advertisement delivery system of the reward-for-performance type).

### DISCLOSURE OF INVENTION

When the system applying the foregoing affiliate program is used, it is often perceived that a high value for money performance, given the actual amount paid for the advertisement, can be obtained in comparison with a general advertisement. However, as it presently stands, the level of adoption of such a system is low.

The prevalence status of an affiliate program will now be described.

The market size of Internet shopping has grown rapidly in the last few years. According to an actual condition survey of the market size regarding E-commerce in the fiscal 2004 year, the market size in Japan for the year 2004 reached 5.643 trillion yen, increasing by 28% from the previous year's 4.424 trillion yen, and this growth is showing no signs of abating. With the expanding market indicated by the number of broadband users having reached 30 million, and the number of Internet users having reached 70 million, the purchase of commodities and services by Internet users through use of personal computers reached 38% in 2004. As mentioned above, it is perceived that Internet shopping has been established as a new form of shopping.

However, according to a publication by the Japan Affiliate Service Kyokai, which is the mainstream service of the affiliate industry, affiliate associated sales being paid by advertisers that had a contract with the seven (7) major affiliate companies in the year 2006 is approximately 30.1 billion yen, which is only a small contribution to the market size of Internet shopping as it now stands.

Several causes can be considered as reasons for this and these are detailed below.

### <The Reason Why Affiliate Associated Sales are Not Readily Adopted>

1. The affiliate entities (being the seven companies in the Japan Affiliate Service Kyokai) impose an expensive initial registration fee of 50,000 to 100,000 yen as well as an average monthly fee of slightly less than 50,000 yen regardless of sales, imposing a large financial burden on exhibitor shops.

2. Since the affiliates want to receive a large amount of compensation by dealing with commodities with a high level of compensation, the affiliates tend to not be interested in a low level of compensation. However, since the mechanism is designed to charge a usage fee in proportion to the amount of affiliate compensation configured by the affiliate entity, even though an exhibitor shop might want to set a higher level of affiliate compensation, setting a higher level of affiliate compensation causes a larger financial burden, and thus the current status quo does not allow for large expansion even if an exhibitor shop wishes to enhance its sales through affiliates.

3. Since the affiliate entities do not provide support activities for exhibitor shops, such as notification of commodities of the exhibitor shops, and only provide a mechanism for imposing the burden of the cost of advertising, such as click advertisements, on the exhibitor shops, the exhibitor shops are forced to provide sales activities, such as paid advertisements, which are accompanied by a large financial burden.

4. In order to use an affiliate entity, the present mechanism forces exhibitor shops to make an effort to register for the service of the affiliate entity, being separate from a shopping cart supplier or the like, making the maintenance of services being provided complicated as well as necessitating a very cumbersome workload with respect to the sales operation.

As described above, the current mechanism of the affiliate industry takes the mechanism used by the seven companies of the Japan Affiliate Service Kyokai as a standard. However, since the mechanism used by the seven companies of the Japan Affiliate Service Kyokai itself imposes a burden on exhibitor shops, there is a problem of not being able to introduce a new affiliate due to the large burden, even if such an introduction is desired.

The present invention has been created in light of the foregoing circumstances, and the primary purpose of the present invention is to revolutionize the mechanism involved in conventional affiliate sales so as to provide an affiliate system that allows for a significant reduction in the burden imposed on exhibitor shops. More particularly, the present invention aims to provide an affiliate system that performs billing and compensation payment processing in the affiliate sales system by linking with the clearing process for the cost of the commodity purchased in the clearing system so that any cumbersome work or processing at the exhibitor shop site can be made unnecessary.

The present invention relates to an affiliate system that provides an affiliate service, and the above-mentioned purpose of the present invention can be achieved by an affiliate system, wherein a shop site exhibiting sales target commodities to virtual shops, an affiliate site introducing said commodities, an affiliate sales system providing affiliate services and a clearing system performing the clearing process are connected with each other via a network, and the affiliate system having a billing API specifying the data transmission method involved in the billing and clearing of said affiliate services between said affiliate sales system and said clearing system, and wherein said clearing system comprises an affiliate linkage process means which sends a clearing completion notice including the clearing information on the cost of the commodity purchased by a user at said shop site to said affiliate sales system in accordance with said billing API as well as receiving the following compensation information from said affiliate sales system in accordance with said billing API, and performs the process of transferring to the shop account of said shop site the balance of said cost of the commodity from which said compensation is deducted, and said affiliate sales system comprises a clearing linkage process means which receives said clearing completion notice from said clearing system in accordance with said billing API as well as determining the amount of compensation for the affiliates that introduced the commodities purchased by said user and returning compensation information including the amount of the compensation to said clearing system.

The above-mentioned aim of the present invention can be further effectively achieved by said affiliate sales system having; a means of storing in a database the commodity category for which said affiliates was approved for advertisement in coordination with the affiliate ID identifying said affiliates and the mail address of said affiliates, and a means of, upon posting of a new commodity in said shop site, reading out from said database said stored affiliate ID and mail address corresponding to the commodity category to which said new commodity belongs, and automatically delivering a notice mail including the information of said new commodity to each affiliates via said network.

Furthermore, the above-mentioned aim of the present invention can be even more effectively achieved by; said affiliate linkage process means, at the point in time of sending the order reception completion notice of said commodity to said shop site, sending said clearing completion notice to said affiliate sales system; said affiliate linkage process means, upon withdrawal of said cost of the commodity from the account of said user in accordance with either real-time clearing or credit clearing, sending said clearing completion notice to said affiliate sales system; said affiliate linkage process means, at the point in time the cooling-off period of said commodity has expired, sending said clearing completion notice to said affiliate sales system; and said affiliate linkage process means, at the point in time the cooling-off period of said commodity has expired and also the valid return period of said commodity has expired, sending said clearing completion notice to said affiliate sales system.

### EFFECT OF THE INVENTION

According to the present invention, for the clearing completion notice from the clearing system, compensation information is returned from the affiliate sales system and the balance of the cost of the commodity from which the compensation is deducted is then automatically transferred to the account of the shop site on the clearing system side, thus the work to incorporate a commodity tag into the shopping cart and the work to approve and count the sales for each commodity tag becomes unnecessary on the shop site side, thereby significantly reducing the burden imposed on the exhibitor shops. In addition, by comprising a means of, upon posting a new commodity on the shop site, automatically delivering a notice mail regarding the new commodity to the affiliates to which the category that the commodity belongs to is registered, it will be unnecessary for the advertiser to perform the approval work or to inform the affiliates of the permission of use of the commodity every time an application for a new commodity is made by the affiliates.

### BRIEF DESCRIPTION OF THE DRAWINGS

FIG. 1 shows a pattern diagram indicating the process flow in a conventional affiliate system.

FIG. 2 shows a pattern diagram describing the mechanism of the billing and clearing method in a conventional affiliate system.

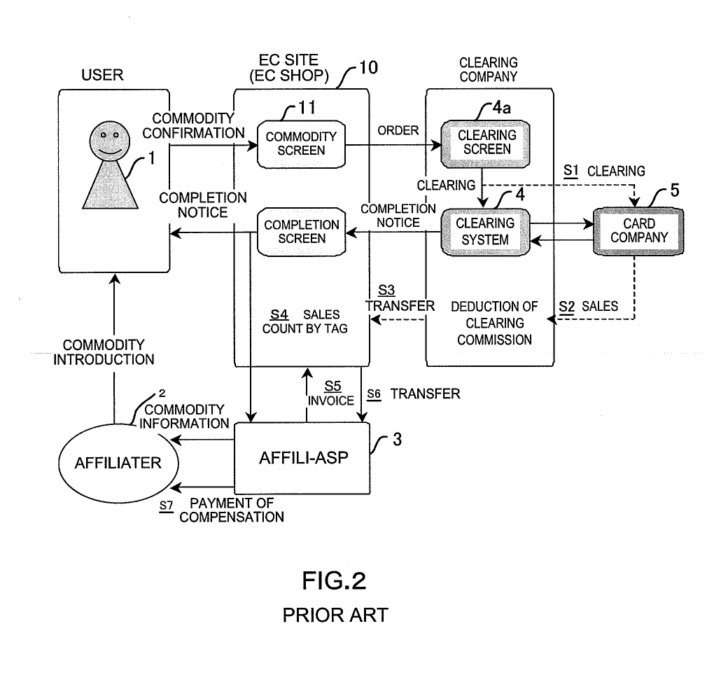

FIG. 3 shows a block diagram illustrating an example of the entire configuration of the affiliate system according to the present invention.

FIG. 4 shows a pattern diagram indicating the process flow in the affiliate system according to the present invention.

FIG. 5 shows a pattern diagram indicating the mechanism of the billing and clearing method in the affiliate system according to the present invention.

FIG. 6 shows a flowchart describing the linkage process of the affiliate sales system and the clearing system according to the present invention.

### EXPLANATION OF SYMBOLS

1 User
2 Affiliates
3 ASP (old system)
4 Clearing system (current system)
5 Card company
6 Advertiser (shop)
10 EC site (shop site)
11 Commodity screen
11a Commodity list
11A Shopping cart
20 Weblog
21a Commodity introduction page
30 Affiliate sales system
31 Purchase screen
31a Purchase page
32 Clearing linkage process part
33 Compensation determining part
34 Group of databases
40 Clearing system
41 Clearing screen
41a Clearing page
42 Affiliate linkage process part
43 Clearing process part

### DETAILED DESCRIPTION OF THE PREFERRED EMBODIMENTS

With reference to the drawings, a preferred embodiment of the present invention will now be described hereinafter.

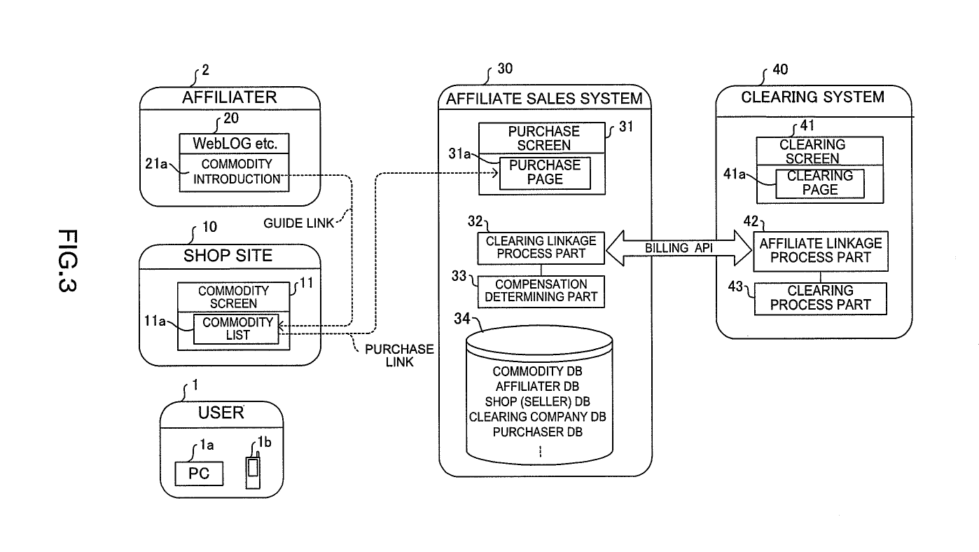

FIG. 3 shows a block diagram illustrating an example of the entire configuration of the affiliate system according to the present invention. The “affiliate system”, as referred to in the present invention, means the system of an ASP (Affiliate Service Provider) in the narrower sense, while, in the broader sense, means the entire computer network system, as shown in FIG. 3. The ASP's computer system is referred to as an “affiliate sales system” (or “ASP”), and the entire system is referred to as an “affiliate system” in the following description.

The affiliate system according to the present invention comprises an EC (Electronic Commerce) site 10 (being a computer of the EC site, hereinafter referred to as “shop site”) which exhibits sales target commodities (being digital contents or goods) to virtual shops in a network such as an electronic shopping mall, an affiliate site 20 (being a computer that posts weblogs, e-mail newsletters, homepages, or the like) provided by affiliates, an affiliate sales system 30 which provides affiliate services, and a clearing system 40 which performs the clearing process with the computer of each card company, wherein all of above are interactively connected via a network such as the Internet in order to allow communications.

The communication terminals (1a and 1b) of a user 1 are information processing terminals equipped with a browser, which may be any information processing device having an Internet connection function, such as a personal computer (PC), a mobile phone, a PDA (Personal Digital Assistants), or the like.

The affiliate sales system 30 is an information processing system operated and managed by the ASP (Affiliate Service Provider), which is a core computer system that performs the overall information processing involved in the affiliate services, such as the billing process for compensation and the clearing process, by linking with the clearing system. The affiliate sales system 30 comprises several computers such as a Web server, a database server, a mail server and administrative server, and databases 34 in order to achieve an affiliate program.

The databases 34 comprise; a commodity database storing information on the commodities exhibited in the shop site 10 in coordination with the commodity ID and the category ID that indicates the category of the commodity, an affiliates information database storing the information of an affiliates 2 (name, address, e-mail address, target transfer account for payment of compensation, commodity category ID for which an approval for commodity introduction was received from the advertiser, and the like) in coordination with the affiliates ID (an identifier to identify the affiliates), a shop database storing the information (target transfer account and the like of the commodity sales amount) on shops (sellers) in coordination with their shop ID, a clearing company database storing the information (API protocol and the like for use with the clearing system) on clearing companies in coordination with their clearing company ID, a purchaser database storing user information such as the name, address, e-mail address, authentication information on the online clearing of the commodity purchase amount, and card information and the like on the user 1 in coordination with the user ID.

In this embodiment of the present invention, the affiliate sales system 30 is provided with an API (Application Program Interface) specifying the data transmission method involved in the billing and clearing of the affiliate service as an application layer interface with the clearing system 40, and uses the API (hereinafter referred to as “billing API”) to link the affiliate sales system 30 with the clearing system 40 so as to automatically perform the transfer process of the sales amount for the EC shop and the compensation payment process for the affiliates.

The linkage process between the affiliate sales system 30 and the clearing system 40 using the above-mentioned billing API will be described later in this description. First, the basic process of the affiliate sales system according to the present invention will be described.

### <<Basic Process in the Affiliate Sales System 30>>

<<1. Registration Process of Seller Information>>

First, the registration process of seller information will be described.

The seller who sells commodities in the shop site 10 accesses the Web server within the affiliate sales system 30 from a communication terminal such as a PC, and enters their seller information (name, address, phone number, password, bank account information, seller ID, and the like) in accordance with the guidance displayed on the registration screen of the seller, and then sends this information to the Web server. The Web server registers the information to the databases 34 (shop DB) in such a manner that the information is searchable via the shop ID and seller ID, and then the registration process of the seller information is completed (see Step S5). With respect to this information, the registration of the seller information is primarily aimed at the accumulation of seller information in compliance with local laws and regulations as well as the accumulation of the transfer information regarding sales.

<<2. Registration Process of Affiliates Information>>

Next, the registration process of the information on the affiliates 2 will be described. Since the actions involved in the information registration process are similar to the registration process of the seller information, only a brief description will be provided below.

The information registration screen displayed on the display part of the communication terminal of the affiliates 2 is provided with their affiliates information (the name, address, phone number, secret key (password), bank account information, and affiliate ID, and the like of the affiliates 2), and the Web server receives the affiliates information and registers the information on the databases 34 (affiliates DB) in such a manner that the information is searchable via the affiliate ID or other affiliate information. The affiliate ID becomes the introduction ID of the sale.

<<3. Registration Process of Commodity Information>>

Next, the registration process of the information on the commodity exhibited by a shop (seller) will be described.

The commodity information registration screen displayed on the display part of the communication terminal of a seller is provided with entry fields for the commodity name, offer price, description of the commodity, URL of the seller page in the shop site 10, photographs of the commodity, and the like, and the seller 1 enters the information on the desired-to-sell commodity on the screen. The Web server in the affiliate sales system 30 receives the commodity information and automatically grants it a commodity ID (in this example, indexing a commodity number nnn which is unique to the system), then the information is registered to the databases 34 (commodity DB) in such a manner that the information is searchable using the commodity ID and the seller ID for identifying the seller and the like.

<<4. Generation Process of Affiliate Link>>

Next, the generation process of the affiliate link (hereinafter referred to as “guide link”) for guiding purchasers to the web pages of sellers in the shop site 10 will be described.

First, when the affiliates 2, which registered the above-described affiliates information, wants to introduce commodities in its own site, it accesses the affiliate sales system 30 from a communication terminal. After the affiliate sales system 30 authenticates the affiliates 2 by checking their login ID and password, it displays a screen 11 with a commodity list which lists the commodities on the display part of the communication terminal. The affiliates 2 selects preferred commodities from among the commodity list 11a and pastes the guide link to its own weblog or e-mail newsletter so as to guide purchasers. In this embodiment of the present invention, the unit in which the advertiser permits the introduction of commodities for the affiliates 2 is on the category basis of the commodity, and when new commodities belonging to such a category are posted to the shop site, the affiliate sales system automatically informs the affiliates 2 of a list of the new commodities by an e-mail. Therefore, preferred commodities can be selected from the list of new commodities that the affiliates 2 was informed about via the e-mail, and the guide link can be pasted to the affiliater's own weblog or e-mail newsletters.

The above-mentioned guide link is an Affiliate-Link provided by the affiliate sales system 30. The Affiliate-Link, for example, is composed of URL information wherein the affiliate ID, the URL of the seller page, and the commodity ID are added to the URL of the affiliate sales system 30 as an argument. For example, when the user 1 (being a person interested in purchasing) clicks the introduced commodity 21a on the Web screen of the affiliate site 20 shown in FIG. 3, the clicking takes the user 1 to the link destination that is the URL of the seller's page via the first access destination that is the affiliate sales system 30, and then the information on the commodity 11a corresponding to the commodity ID is displayed on the display part of the communication terminal of the user 1. In so doing, the affiliate sales system 30 extracts the information on the commodity from the commodity database based on the commodity ID within the guide link while recognizing the access destination, that is, the URL of the seller page from the URL of the seller page within the guide link. In addition, the introducer of the commodity identifies the introducer (affiliates 2) based on the affiliate ID within the guide link and then extracts the information on the affiliates 2 from the affiliates information database.

<<5. Guide Process to Seller Page by Address Conversion>>

Next, the guide process to the seller page will be described.

One of the features of the affiliate sales system 30 is to guide users to the seller page. This guide can compensate for a lack of information about a commodity, as is often the case when exhibiting on an ordinary shopping site, thereby an effect of stimulating buying motive can be expected.

In so doing, the affiliate sales system 30, when the guide link is clicked on the Web page (on the screen of the terminal of the user 1) of the weblog or e-mail newsletter of the affiliates 2, obtains the URL of the seller page from within the guide link, and converts the access destination address into the URL address of the seller page so as to jump to the seller page indicated by the URL.

<<6. Purchase Link Being Configured on Seller Page>>

Next, the purchase link being configured on the seller page will be described.

The affiliate sales system 30 uses the guide link to convert to the URL of the seller page so as to guide the user to the seller's page (the page on which the commodity 11a on the commodity screen 11 in FIG. 3 is displayed). However, even if guiding a user to the seller page, the sale would not go through until the user actually purchases, therefore, a purchase link is configured on the seller page in advance (for example, URL information in which the commodity ID is added to the URL of the affiliate sales system 30 as an argument). When the user 1 clicks the purchase link on the seller page, the clicking takes the user 1 to the affiliate sales system 30 and the affiliate sales system then sends the screen data of the purchase page 31a to the user terminal 11c so that the purchase page screen 31 appears on the display part of the user terminal. The user 1, when purchasing the commodity, selects the manner of clearing (credit card, bank transfer, or the like) and then enters their user ID, password and other information on the screen 41 of the clearing page 41a in accordance with the manner of clearing being used before clicking the purchase button in order to purchase the desired commodity. In so doing, in the case where the user information has been previously registered to the above-described purchaser database, the entry of the card information is unnecessary, and subsequently the clearing process will be performed with the computer of the card company via the clearing system 40 based on the account information in accordance with the manner of clearing selected by the user.

Since the diversion to the seller page generally causes the introducer's affiliate ID to be erased, this embodiment of the present invention may adopt the configuration of storing, in information storage media, the information in which the seller ID and affiliate ID for identifying the commodity ID or the seller are recorded in response to the click operation of the guide link being displayed on the screen of the user terminal. By adopting this configuration, the method can be independent of the type of the client terminal used. Alternatively, the method may store the affiliate ID once in a cookie using the guide link, and upon clicking the purchase link, may restore the affiliate ID in order to restore the introducer's affiliate ID so as to generate the affiliate compensation for the introducer being identified by the affiliate ID.

Next, the linkage process between the affiliate sales system 30 and the clearing system 40 will be described.

The affiliate system according to the present invention calls for the above-described billing API during the process of performing the billing and clearing process for the commodity ordered by the user 1 in the shop site 10, and gives and receives detail data (detail data in relation to the clearing process and the payment process of the commodity introduction fee) between the clearing process 40 and the affiliate sales system 30 so as to integrate the clearing process for the cost of the commodity in the clearing process 40 with the billing process and the compensation payment process in the affiliate sales system 30.

In FIG. 3, the clearing system 40 comprises; the affiliate linkage process means (affiliate linkage process part 42) that performs both the process of sending the clearing information on the cost of the commodity (cost of commodities purchased by the user 1 in the shop site 10) to the affiliate sales system 30 and the process of receiving the compensation information from the affiliate sales system 30 in accordance with the billing API protocol which specifies the method of giving and receiving information with the affiliate sales system 30; and the clearing process means (clearing process part 43) that performs the process of determining the cost of the commodity to be transferred to the exhibitor shop (seller) account based on the compensation information received by the affiliate linkage process part 42, and transfers the payment for the commodity to the exhibitor shop (seller) account.

Conversely, the affiliate sales system 30 comprises; the clearing linkage process means (clearing linkage process part 32) that performs the process of receiving the clearing information from the clearing system 40 and the process of determining the affiliate compensation (compensation to be paid to the affiliates who introduced such commodities) based on the received clearing information as well as returning the compensation information including the determined affiliate compensation to the clearing system 40 in accordance with the above-mentioned billing API protocol; and the compensation determining means (compensation determining part 33) that performs the process of determining the above-mentioned affiliate compensation in accordance with the sales amount of the commodities based on the above-mentioned clearing information.

The name of each of the above-mentioned means is provided only for the convenience of explanation and should not be construed as a limitation on the software configuration or the order of the processes. The program and set of control data for having the computer perform the procedure of integrating the foregoing clearing process with the process involved in the affiliate service are stored in an external storage media while also being stored in the storage means of the computer (affiliate sales system 30, clearing system 40) within the affiliate system.

In the foregoing configuration, the process flow of the affiliate system according to the present invention, including the linkage process between the affiliate sales system and the clearing system according to the present invention, have been described.

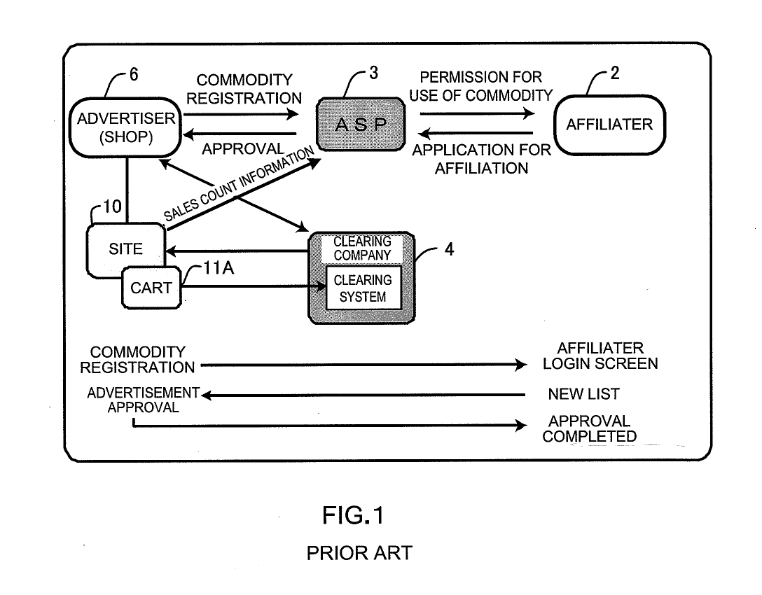

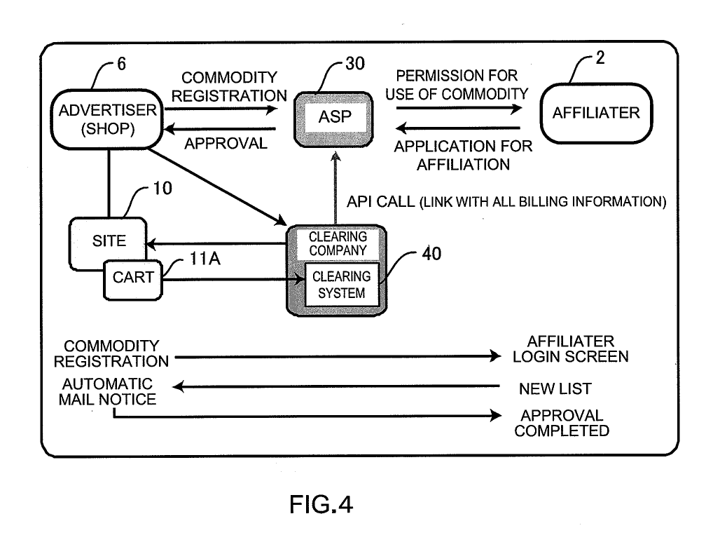

FIG. 4 shows a pattern diagram indicating the process flow, corresponding to FIG. 1, in the affiliate system according to the present invention.

With reference to FIG. 1 and FIG. 4, an overview of the process in the affiliate system according to the present invention and the key differences from a conventional system will now be described. P1 to P5 shown in FIG. 4 are not intended to indicate the order of the process. In this embodiment of the present invention, the order of the process follows from P1 to P2, P4, P5, P3 and then to P6.

The conventional system illustrated in FIG. 1 stores the tag information by incorporating the tag into the shopping cart of the shop site (EC site) so as to count up the sales corresponding to the commodity tag every time a sale of the ordered commodity is generated. The ASP adopts the method of performing the compensation payment process for the affiliates based on the sales count information uploaded from the shop site. Conversely, in this system, the clearing system 40 adopts the method of integrating the clearing process for the cost of the commodity in the clearing system 40 with the billing process and the compensation payment process in the affiliate sales system 30 by calling for the billing API in the process of performing the billing and clearing process for the ordered commodities (“API call” in FIG. 4) and giving and receiving detail data involved in the billing and clearing process between the clearing system 40 and the affiliate sales system 30. The details of the linkage process using the above-mentioned billing API will be described later in this description.

As opposed to the conventional system which adopts the method wherein the advertiser performs the approval work every time an application for a new list (new commodities) is made from the affiliates and then informs the affiliates of the permission for use of such commodities (see the “advertisement approval” flow in FIG. 1), this system adopts the method wherein the advertiser 6 informs the affiliates of the permission for use of the commodities in the various categories for the affiliates 2 while storing in the affiliates DB the categories to which the commodities, that are permitted for use for the affiliates 2 by the advertiser, belong in coordination with the affiliate ID and, thereafter, whenever the exhibitor shop posts a new commodity on the shop site 10, a notice mail (e-mail) including the commodity information on the new commodity is automatically delivered to the affiliates 2 to which the category dealing with the commodity is registered. Therefore, in this system, the advertiser 6 is no longer required to perform the approval work every time an application for a new list is made from the affiliates 2, and therefore, if the new commodities belong to a category for which the permission of use has been granted, the affiliates 2 is no longer required to perform the application work to the advertiser 6, thereby enabling the advertiser 6 to receive information on new commodities at all times for the categories associated with the commodities that it, the advertiser 6, deals with.

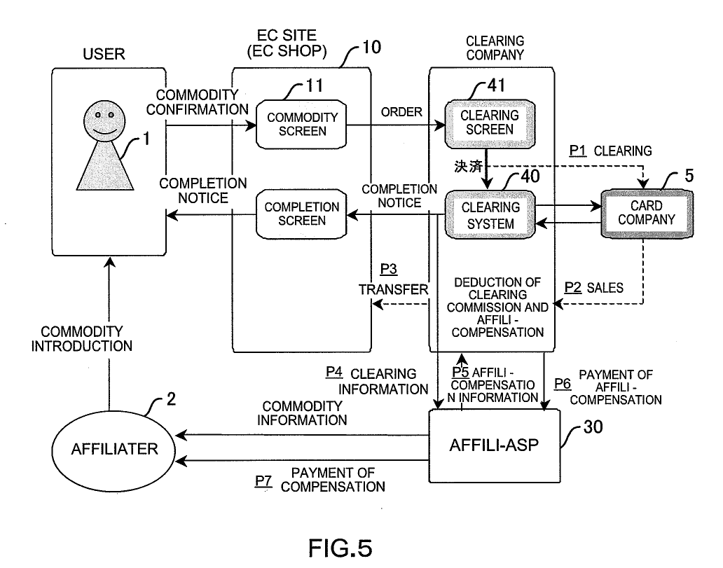

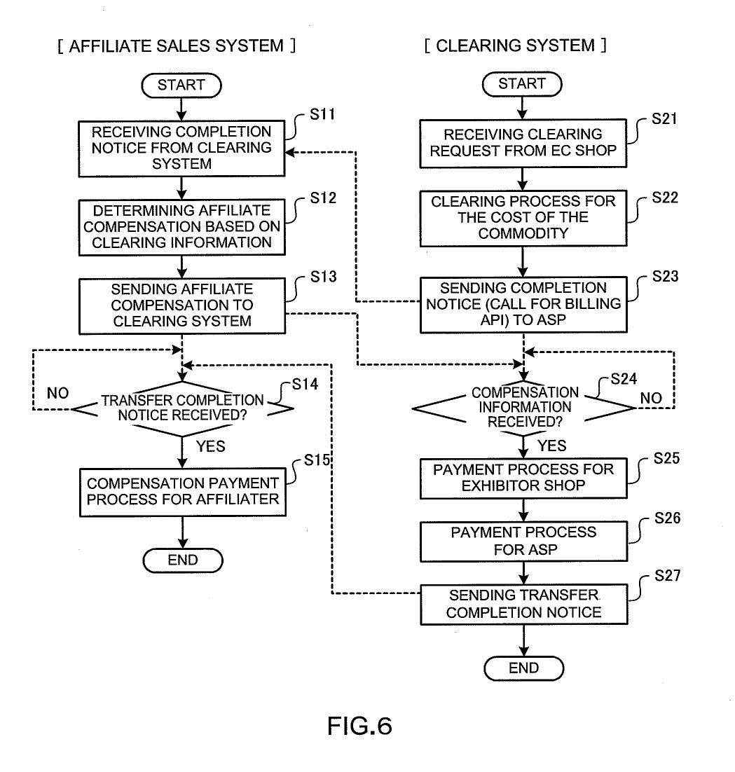

With reference to the pattern diagram shown in FIG. 5 indicating the mechanism of the billing and clearing method and the flowchart shown in FIG. 6, the mechanism of paying the compensation to the affiliates will now be described in further detail. The above-described processes and those similar to conventional processes are either described briefly in this description, or are omitted as necessary.

The shop site 10 that receives an order for a commodity from a terminal of the user 1 sends the order information on the commodity to the clearing system 40 of the clearing company in order to request the clearing of the cost of the commodity. The clearing system 40 that receives the clearing request processes the user authentication with the computer of a card company 5 corresponding to the card number of the user 1 based on the information supplied, and subsequently sends the completion notice (order reception completion notice) to the shop site 10. The shop site 10 that receives the completion notice from the clearing system 40 displays a completion screen as a notice on the display part of the user terminal in order to inform the user 1 of the completion of the order reception of the commodity (see Steps S21 and S22 in FIG. 6).

The clearing system 40 sends the above-mentioned completion notice to the shop site 10 while calling for the billing API so as to send the clearing completion notice, including the clearing information on the cost of the commodity, to the affiliate sales system 30 (see Step S23 in FIG. 6 and Step P4 in FIG. 5).

The affiliate sales system 30 that receives the clearing completion notice from the billing API determines the affiliate compensation in accordance with the sales amount of the commodities sold based on the clearing information included in the clearing completion notice so as to return the compensation information to the clearing system 40 using the billing API (see Step S11 to S13 in FIG. 6, and P5 in FIG. 5).

The clearing system 40 that receives the compensation information from the affiliate sales system 30 based on the received compensation information, the clearing information on the cost of the commodity and the configured information on the clearing commission, then performs a payment process for the exhibitor shop by transferring the balance of the commodity sales amount from which the affiliate compensation and clearing commission (a% of sales, for example, where a=0.5) were deducted, to the specified account of the shop (seller) registered in the shop DB (Steps S24, S25 in FIG. 6, and P3 in FIG. 5), performs the process of transferring the affiliate compensation to the account of the ASP entity for the affiliate sales system 30 based on the compensation information received from the affiliate sales system 30 (Step S26 in FIG. 6, and P6 in FIG. 5), and then sends the clearing completion notice to the affiliate sales system 30 (Step S27 in FIG. 6) in order to complete the clearing process for the commodity sold.

If the sold commodity was introduced by the affiliates 2, the affiliate sales system 30 that received the clearing completion notice from the clearing system 40 performs the payment process for the affiliates 2 by transferring the compensation, that is, the affiliate compensation from which the system usage fee is deducted, to their account (see P7 in FIG. 5). In so doing, the commodity information is sent to the terminal of the affiliates 2 in order to inform them that the introduced commodity has been sold (and notify them of the completion of the transfer to their account), completing the compensation payment process (Steps S14 and S15 in FIG. 6).

The “affiliate compensation” as referred to herein is the total amount of the system usage fee to be paid to the ASP 30 and the compensation to be paid to the affiliates 2 by the exhibitor shop. In this embodiment of the present invention, the system usage fee of the ASP 30 is set to β% of sales (for example, where β=4.5), and the compensation for the affiliates 2 is set to a compensation amount that is predetermined for the commodity between the advertiser and the affiliates (compensation registered to the ASP database). The system usage fee that is paid by the exhibitor shop to the ASP entity is set to free of charge for the initial registration fee and the monthly usage fee, and the usage fee is set to be only in accordance with the sales (β% of sales) as mentioned above, thus allowing the system to alleviate the burden imposed on the exhibitor shops as much as possible.

The call to the above described billing API (transmission of the clearing completion notice to the ASP) can obtain a first process form which generates the completion notice (order reception completion notice) at the point in time of sending it to the shop site 10, a second process form which generates the completion notice at the point in time of withdrawing the cost of the commodity from the user account in accordance with either real time clearing or credit clearing, a third process form which generates the completion notice at the point in time the cooling-off period (cancelable period) of the commodity has expired, or a fourth process form which generates the completion notice at the point in time the cooling-off period of the commodity has expired and also the valid return period of the commodity has expired. Although this embodiment of the present invention employs the first process form, any of the above process forms may be employed. In addition, when there are several clearing systems 40, the process form may be separately configured for each clearing company.

As described above, with regard to the flow of money in a conventional affiliate system, the ASP company sends an invoice based on the results of counting the sales regardless of the sequence of the flow of purchase, clearing and sales transfer, and subsequently the shop pays via a transfer, making it the source for paying the compensation to the affiliates. However, the system of the present invention has the database of the affiliate sales system (ASP) link with the completion notice of the clearing system of the clearing company, and thus the clearing company pays the balance from which the affiliate-compensation has been deducted to the shop and pays the affiliate-compensation to the ASP so as to pay the compensation to the affiliates. As a result, the clearing company transfers the balance from which the affiliate-compensation has been deducted to the shop after calculating the aggregation of the sales, and thus both the shop and the ASP are able to completely omit any unnecessary workload, in comparison with the conventional method where both the shop and the ASP were required to create invoices, and the shop was required to undertaken extra work in order to check and transfer the amount.

In addition, since the conventional affiliate system is not integrated with the clearing system, there are cases where the sales do not correspond to the number of affiliates. Moreover, since the clearing system is not integrated with the cancel and chargeback of the clearing system, those processes cannot be fully handled by others. However, the system of the present invention allows for full accordance between the sales and the number of affiliates.

1. An affiliate system, wherein a shop site exhibiting sales target commodities to virtual shops, an affiliate site introducing said commodities, an affiliate sales system providing affiliate services, and a clearing system performing a clearing process are connected with each other via a network, and
the affiliate system has a billing API specifying the data transmission method involved in the billing and clearing of said affiliate services between said affiliate sales system and said clearing system, wherein
said clearing system comprises an affiliate linkage process means which sends a clearing completion notice, including the clearing information on the cost of the commodity purchased by a user at said shop site, to said affiliate sales system in accordance with said billing API as well as receiving the following compensation information from said affiliate sales system in accordance with said billing API, and performs the process of transferring to the shop account of said shop site the balance of said cost of the commodity from which said compensation is deducted, and
said affiliate sales system comprises a clearing linkage process means which receives said clearing completion notice from said clearing system in accordance with said billing API as well as determining the amount of compensation for the affiliates that introduced the commodities purchased by said user and returning compensation information including the amount of the compensation to said clearing system.

2. The affiliate system as claimed in claim 1, wherein said affiliate sales system has a means of storing in a database the commodity category for which said affiliates was approved for advertisement in coordination with the affiliate ID identifying said affiliates and the mail address of said affiliates, and a means of, upon posting of a new commodity in said shop site, reading out said stored affiliate ID and mail address corresponding to the commodity category to which said new commodity belongs and automatically delivering a notice mail including the information on said new commodity to each affiliates via said network.

3. The affiliate system as claimed in claim 1, wherein said affiliate linkage process means, at the point in time of sending the order reception completion notice of said commodity to said shop site, sends said clearing completion notice to said affiliate sales system.

4. The affiliate system as claimed in claim 1, wherein said affiliate linkage process means, upon the withdrawal of said cost of the commodity from the account of said user in accordance with either real time clearing or credit clearing, sends said clearing completion notice to said affiliate sales system.

5. The affiliate system as claimed in claim 1, wherein said affiliate linkage process means, at the point in time the cooling-off period of said commodity has expired, sends said clearing completion notice to said affiliate sales system.

6. The affiliate system as claimed in claim 1, wherein said affiliate linkage process means, at the point in time the cooling-off period of said commodity has expired and also the valid return period of said commodity has expired, sends said clearing completion notice to said affiliate sales system.
